(19) United States
(12) Patent Application Publication
(10) Pub. No.: US 2024/0159041 A1
(43) Pub. Date: May 16, 2024

(54) Electric Vehicle Battery Service Station with Retractable Walls

(71) Applicant: Ample, Inc., San Francisco, CA (US)

(72) Inventor: Eric Miller, San Francisco, CA (US)

(21) Appl. No.: 18/509,646

(22) Filed: Nov. 15, 2023

Related U.S. Application Data
(60) Provisional application No. 63/383,772, filed on Nov. 15, 2022.

(51) Int. Cl. E04B 1/343; B60L 53/30

(52) U.S. Cl. CPC E04B 1/34312; B60L 53/30; B60S 5/00

(57) ABSTRACT

An electric-vehicle (EV) battery service station including a platform configured to receive an EV and a housing attached to the platform, the housing including a stationary housing wall and a roof attached to the stationary housing wall, the roof overhanging the platform. A plurality of retractable walls are attached to the roof, the retractable walls having a raised state in which the retractable walls are raised to allow the EV to drive onto or off of the platform and a lowered state in which the retractable walls extend to the platform such that the stationary housing wall, the retractable walls, the roof, and the platform define an EV service chamber. One or more motors is/are in mechanical communication with the retractable walls to transition the retractable walls between the raised and lowered states.

### CROSS-REFERENCE TO RELATED APPLICATIONS

This application claims priority to Application No. 63/383,772, titled “Electric Vehicle Battery Service Station With Retractable Walls,” filed on Nov. 15, 2022, which is hereby incorporated by reference.

### TECHNICAL FIELD

This application relates generally to service stations, namely battery servicing stations for electric vehicles (EVs).

### BACKGROUND

In order to replenish the energy of depleted batteries in an EV, the depleted batteries can either be recharged or replaced or swapped with charged batteries. Swapping depleted batteries for charged batteries is analogous to refilling the tank of a conventional vehicle with fuel. Though conventional vehicles have access to an infrastructure of conventional fuel (e.g., gas) stations, the analogous infrastructure for battery-swapped EVs is not yet available.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a portable electric-vehicle (EV) battery service station, comprising a platform configured to receive an EV; a housing attached to the platform, the housing including a stationary housing wall and a roof supported by the stationary housing wall, the roof overhanging the platform; a plurality of retractable walls attached to the roof, the retractable walls having a raised state in which the retractable walls are raised to allow the EV to drive onto or off of the platform and a lowered state in which the retractable walls extend to the platform such that the stationary housing wall, the retractable walls, the roof, and the platform define an EV service chamber; and one or more motors in mechanical communication with the retractable walls to transition the retractable walls between the raised and lowered states.

In one or more embodiments, the stationary housing wall is a first stationary housing wall, the housing includes a second stationary housing wall attached to the roof, and the platform is located between the first and second stationary housing walls. In one or more embodiments, the portable EV battery service station further comprises a first ramp attached to a first side of the platform; and a second ramp attached to a second side of the platform, the first and second ramps aligned along an axis. In one or more embodiments, the one or more motors is/are wall motor(s), the platform is configured to telescope between an extended state and a contracted state, and one or more platform motors is/are in mechanical communication with the platform to transition the platform between the extended and contracted states.

In one or more embodiments, the stationary housing wall defines an EV service-station equipment chamber. In one or more embodiments, the portable EV battery service station further comprises a battery charging rack located in the EV service-station equipment chamber.

In one or more embodiments, the portable EV battery service station further comprises a controller in electrical communication with the motor(s), the controller configured to produce a first motor control signal that causes the motor(s) to transition the retractable walls between the raised and lowered states; and a processor in electrical communication with the controller, the processor configured to produce a processor control signal in response to one or more input signals, wherein the controller produces the motor control signal in response to receiving the processor control signal. In one or more embodiments, the portable EV battery service station further comprises one or more sensors configured to detect a position of the EV with respect to the EV service station, wherein the processor is configured to receive output signals from the sensor(s), the processor is configured to produce a first processor control signal when the processor determines, using the output signals from the senor(s), that the EV is approaching the platform, and in response to receiving the first processor control signal, the controller causes the motor(s) to transition the retractable walls from the lowered state to the raised state.

In one or more embodiments, the processor is configured to produce a second processor control signal when the output signals indicate that the EV is located on the platform and below the roof, and in response to receiving the second processor control signal, the controller causes the motor(s) to transition the retractable walls from the raised state to the lowered state. In one or more embodiments, the processor is configured to produce a third processor control signal after one or more depleted batteries in the EV are exchanged with one or more charged batteries, and in response to receiving the third processor control signal, the controller causes the motor(s) to transition the retractable walls from the lowered state to the raised state.

In one or more embodiments, the sensor(s) include a camera and/or a weight sensor. In one or more embodiments, the processor and the controller are located in the EV service-station equipment chamber.

In one or more embodiments, the portable EV battery service station further comprises a housing-wall extender attached to a top the stationary housing wall and to the roof, the housing-wall extender having dimensions that are configured to increase a height of the roof compared to when the roof is attached to the top the stationary housing wall. In one or more embodiments, the portable EV battery service station further comprises a locking mechanism configured to lock the retractable walls to the platform when the retractable walls are in the lowered state.

Another aspect of the invention is directed to an EV battery service station array, comprising a plurality of platforms, each platform configured to receive a respective EV for a respective EV service station; a housing attached to the platforms, the housing including a plurality of stationary housing walls and a roof attached to the stationary housing walls, the roof overhanging the platforms, wherein each platform is located between a respective pair of stationary housing walls; a plurality of pairs of retractable walls attached to the roof, each pair of retractable walls aligned with a respective platform, each pair of retractable walls having a respective raised state to allow the respective EV to drive onto or off of the respective platform and a respective lowered state in which the respective pair of retractable walls extend to the respective platform such that the respective pair of stationary housing walls, the respective pair of retractable walls, the roof, and the respective platform define a respective EV service chamber; and a respective one or more motors in mechanical communication with each pair of retractable walls to transition the respective pair of stationary housing walls between the respective raised state and the respective lowered state.

In one or more embodiments, the stationary housing walls include first and second outer housing walls and one or more inner housing walls, each inner housing wall located between neighboring EV service chambers. In one or more embodiments, each inner wall defines a respective EV service-station equipment chamber that includes shared equipment for the neighboring EV service chambers. In one or more embodiments, the shared equipment further includes a controller in electrical communication with the respective motor(s) for the pairs of retractable walls of the neighboring EV service chambers; and a processor in electrical communication with the controller, the processor configured to produce a processor control signal in response to one or more input signals.

Another aspect of the invention is directed to an EV battery service station matrix comprising a plurality of EV service station arrays, each EV service station array comprising a plurality of platforms, each platform configured to receive a respective EV for a respective EV service station; a housing attached to the platforms, the housing including a plurality of stationary housing walls and a roof attached to the stationary housing walls, the roof overhanging the platforms, wherein each platform is located between a respective pair of stationary housing walls; a plurality of pairs of retractable walls attached to the roof, each pair of retractable walls aligned with a respective platform, each pair of retractable walls having a respective raised state to allow the respective EV to drive onto or off of the respective platform and a respective lowered state in which the respective pair of retractable walls extend to the respective platform such that the respective pair of stationary housing walls, the respective pair of retractable walls, the roof, and the respective platform define a respective EV service chamber; and a respective one or more motors in mechanical communication with each pair of retractable walls to transition the respective pair of stationary housing walls between the respective raised state and the respective lowered state. The EV service station arrays are aligned such that a first EV service station in each EV service station array is aligned with respect to a first central axis and a second EV service station in each EV service station array is aligned with respect to a second central axis.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a perspective view of an electric-vehicle service station in a first state according to an embodiment.

FIG. 2 is a perspective view of the electric-vehicle service station illustrated in FIG. 1 in a second state according to an embodiment.

FIG. 3A is a perspective view of the EV service station illustrated in FIG. 1 in a third state according to an embodiment.

FIG. 3B is a perspective view of the electric-vehicle service station illustrated in FIG. 1 in a fourth state according to an embodiment.

FIG. 4 is a side view of the EV service station illustrated in FIG. 1 as one of the retractable walls transitions between the contracted and lowered states.

FIGS. 5A and 5B are front views of the EV service station illustrated in FIG. 1 with the retractable walls in a retracted state according to an embodiment.

FIG. 6A is a perspective view of an EV service station in a first state according to another embodiment.

FIG. 6B is a side view of the EV service station illustrated in FIG. 6A in a second state according to embodiment.

FIGS. 7A-7C are front views of the EV service station with the retractable walls in a retracted state according to an embodiment.

FIG. 8 is a perspective view of an EV service station in a first state according to another embodiment.

FIG. 9 is a perspective view of an EV service stations array according to an embodiment.

FIG. 10 is a perspective view of an EV service station matrix according to an embodiment.

FIG. 11 is a detailed view of a region in FIG. 2 according to an embodiment.

FIG. 12 illustrates an example locking mechanism according to an embodiment.

### DETAILED DESCRIPTION

A portable EV service station can be deployed on demand at arbitrary locations to exchange batteries for EVs. For example, the EV service station can be deployed in a parking lot, the side of the road, or another location. The portable EV service station can be transported between one location and another, including for placement on an as-needed basis.

The portable EV service station includes a platform on which an EV can drive onto to receive battery-exchange service. Portable service stations as described may be transported on a wheeled platform, towed or craned into place, or may be assembled on location as best suits an application.

The platform can include ramps on either or both ends to facilitate real-time entry and egress of electric vehicles into and out of the service station, especially where other charging or service infrastructure is housed beneath a vehicle being serviced to provide some vertical clearance thereto. A housing is attached to the platform and includes at least one housing wall and a roof attached to the housing wall(s). Two or more retractable walls are attached to the roof. The retractable walls can be raised to allow the EV to drive onto or off of the platform and can be lowered during EV service. In the lowered state, the retractable walls, the housing wall(s), the roof, and the platform surround the EV and define an EV service chamber. An EV service-station equipment chamber can be defined in one of the housing walls to store or hold equipment to support the battery-exchange service. Examples of the equipment include a battery-charging rack, a controller, a processor, a network interface, and/or one or more motors for the retractable walls. In an example, a matrix of battery module rack placement positions as shown and described below accommodates placement and manipulation of one or more battery modules that are to be swapped in or out of an electric vehicle, charged on said rack, or serviced thereon, or prepared for movement outside the service station itself.

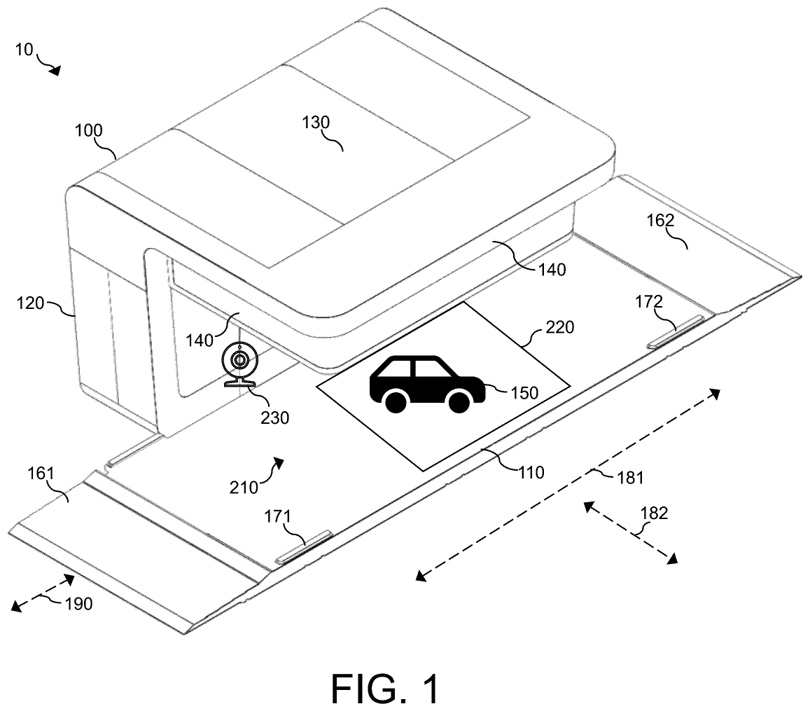

FIG. 1 is a perspective view of an electric-vehicle service station 10 in a first state according to an embodiment. The service station 10 includes a housing 100 and a platform 110 attached to the housing 100. The service station 10 may be portable and formed of modular components/structures.

The housing 100 includes at least one stationary wall 120 (e.g., at least one housing wall) and a roof 130 attached to the wall 120. The wall 120 and the roof 130 can be integrally formed together as a single structure. Alternatively, the wall 120 and the roof 130 can be separate components that are attached together such as by screws, bolts, rivets, interlocking structures, and/or an adhesive.

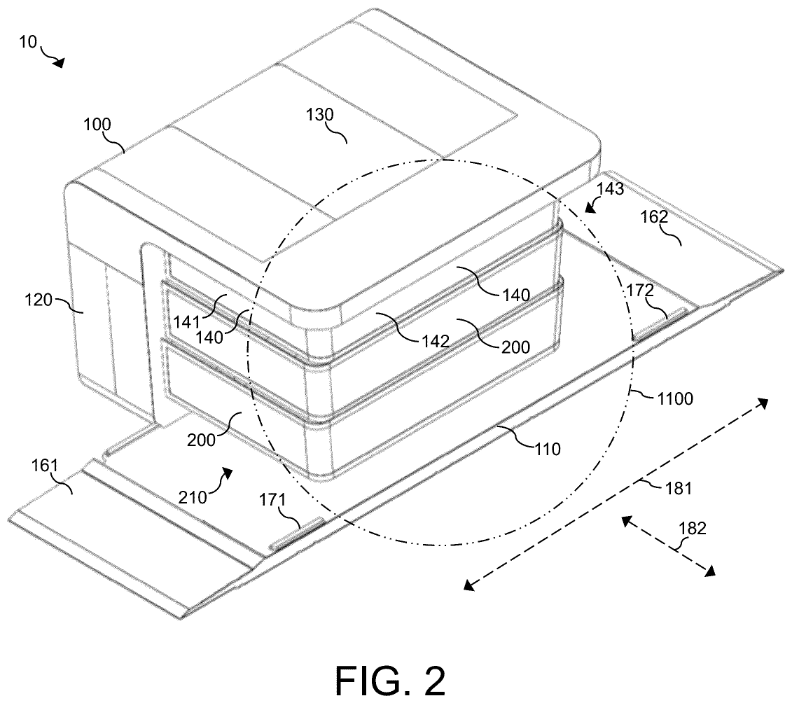

The roof 130 extends over and/or overhangs at least a portion of the platform 110. A plurality of retractable walls 140 are attached to the roof 130. The retractable walls 140 are configured to transition between a retracted state, as illustrated in FIG. 1, and a lowered state, as illustrated in FIG. 2. Three retractable walls 140 are attached to the roof 130 so that when the retractable walls 140 are in the lowered state, the EV 150 is covered and/or enclosed by the retractable walls 140, the roof 130, and the housing wall 120. Only two retractable walls 140 are shown in the perspective view of FIG. 1. The retractable walls 140 can alternately be referred to as retractable doors.

When the retractable walls 140 are in the retracted state, an electric vehicle (EV) 150 can drive onto the platform 110 to receive EV battery service. The EV battery service can include exchanging one or more depleted (or partially depleted) batteries in the EV 150 with one or more charged batteries. The EV battery service can include adding and/or removing one or more batteries to/from the EV 150. In addition, one or more batteries can be added to and/or removed from a charging station or rack in the EV service station 10.

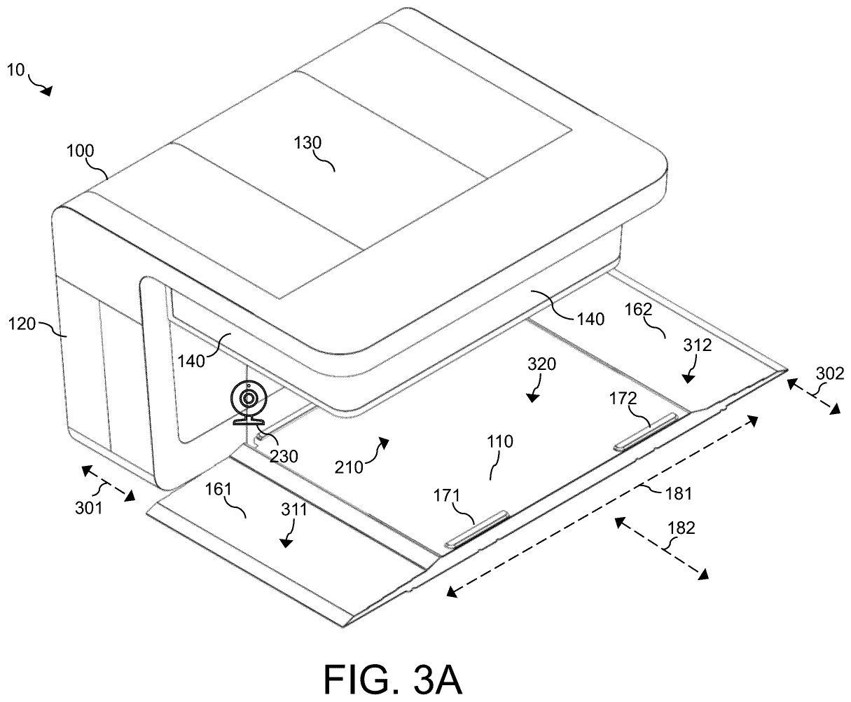

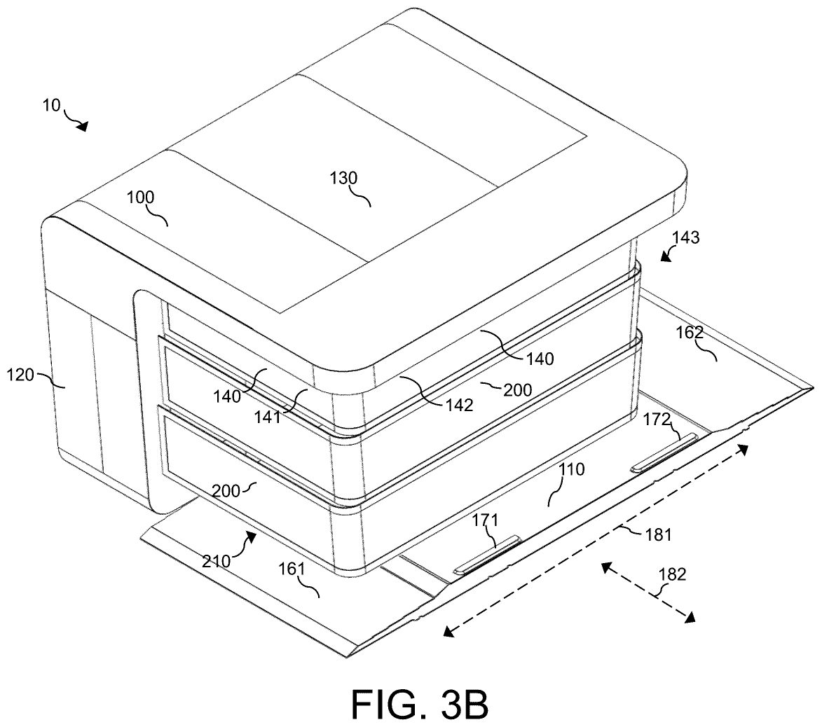

The platform 110 includes first and second ramps 161, 162 for the EV 150 to drive onto and off of the platform 110, respectively. The ramps 161, 162 are on opposing sides (e.g., first and second sides) of the platform 110 and are aligned along a central axis 190 (FIG. 1). The platform 110 can optionally transition between an extended state (FIG. 1) and a contracted state (FIG. 3A). First and second platform motors 171, 172 can be mechanically coupled to the platform 110 to transition the platform 110 between the extended and contracted states. The platform 110 can include a telescoping mechanism to extend and contract the platform 110.

The electric-vehicle service station 10 is sized to receive an EV such as EV 150. For example, the platform 110, the wall 120, and the roof 130 have a length, as measured with respect to a first axis 181 (or with respect to an axis that is parallel to the first axis 181), that is greater than the length of the EV 150. In addition, the platform 110, the wall 120, and the roof 130 have a width, as measured with respect to a second axis 182 (or with respect to an axis that is parallel to the second axis 182), that is greater than the width of the EV 150. The first and second axes 181, 182 are mutually orthogonal. The roof 130 is positioned such that the bottom of the roof 130 is above the top of the EV 150 when the EV 150 is on the platform 110.

FIG. 2 is a perspective view of the electric-vehicle service station 10 in a second state according to an embodiment. In the second state, the retractable walls 140 are in a lowered state and the platform 110 is in the extended state. The retractable walls 140 include multiple longitudinal segments 200 that can slidably engage each other to transition the retractable walls 140 between the retracted and lowered states, such as in a telescoping manner. Each longitudinal segment 200 extends the length of the respective retractable wall 140. For example, the longitudinal segments 200 in retractable wall 141 extend along the length of the retractable wall 141 as measured with respect to the second axis 182 (or with respect to an axis that is parallel to the second axis 182). Similarly, the longitudinal segments 200 in retractable wall 142 extend along the length of the retractable wall 142 as measured with respect to the first axis 181 (or with respect to an axis that is parallel to the first axis 181). The longitudinal segments 200 in retractable wall 143 extend along the length of the retractable wall 143 as measured with respect to the second axis 182 (or with respect to an axis that is parallel to the second axis 182).

In the lowered state, the retractable walls 140 (e.g., retractable walls 141-143) cover and/or enclose by the EV 150. The retractable walls 140 thus function as a telescoping or retractable EV cover. The retractable walls 140, the roof 130, and the housing wall 120 define an EV service chamber 210. The EV (e.g., EV 150) remains in the EV service chamber and protected and/or covered by the retractable EV cover, which can increase safety by forming a physical barrier to prevent pedestrians, children or animals from entering while the EV is serviced. The environment is thus protected from the weather and from accidental or intentional tampering during the service or battery charging procedure thanks to the present retractable wall design.

The EV service station 10 can include one or more sensors to detect whether an EV is on the platform 110 and/or in position to be serviced. For example, a weight sensor 220 (FIG. 1) can be located on or within the platform 110. The weight sensor 220 can be positioned to detect when the EV 150 is located under the roof 130 and between the retractable walls 140 and the housing wall 120, such that the EV 150 will be located in the EV service chamber 210 when the retractable walls 140 are in the lowered state. The weight sensor 220 also detects when the EV 150 has driven off the weight sensor 220 such as when the EV 150 is driving towards the second ramp 162 to leave the EV service station 10 after service.

One or more additional weight sensors can be located on the first ramp 161, the second ramp 162, and/or other portions of the platform 110 (e.g., between the weight sensor 220 and the first ramp 161 and/or between the weight sensor 220 and the second ramp 162) to track the location of the EV 150 as it drives onto and/or off of the platform 110.

Additionally or alternatively, the EV service station 10 can include one or more optical sensors to detect the presence, position, and/or motion of the EV 150. For example, the optical sensors can include a camera 230 that can detect the presence, position, and/or motion of the EV 150. Additionally or alternatively, the optical sensors can include a light detector and a light source (e.g., a laser), such as in a lidar system, to detect the presence, position, and/or motion of the EV 150.

Additional sensors such as radar can be used to detect the presence, position, and/or motion of the EV 150.

The EV service station 10 can also be placed in the second state when the EV service station 10 is not operational (e.g., outside of business hours) to limit access to the EV service station 10.

FIG. 3A is a perspective view of the EV service station 10 in a third state according to an embodiment. In the third state, the retractable walls 140 are in a retracted state and the platform 110 is in the contracted state. In the contracted state, the length of the platform 110, as measured with respect to the first axis 181, is smaller than the length of the platform 110 in the extended state. As a result, the ramps 161, 162 are located closer (e.g., as measured with respect to the first axis 181) together when the platform 110 is in the contracted state compared to when the platform 110 is in the extended state. The platform 110 can telescope between the extended and contracted states. The contracted state provides a smaller footprint for the EV service station 10, which may be advantageous for transporting the EV service station 10 to a given site, such as a parking lot or the side of a street. The smaller footprint may also be advantageous when the EV service station 10 is deployed in a relatively small space and/or to increase the number of EV service stations that can be placed in a given area (e.g., to decrease the number density of EV service stations).

As an additional or alternative embodiment, the first and second ramps 161, 162 can be pivoted inwardly about a respective pivot axis 301, 302 to decrease the footprint of the EV service station 10. For example, the first and second ramps 161, 162 can be pivoted so that they extend upwards in a direction orthogonal to the plane defined by the first and second axes 181, 182. In another example, the first and second ramps 161, 162 can be pivoted so that the respective top surface 311, 312 of the ramps 161, 162, is located adjacent to or in physical contact with the platform 110, in which case the top surface 311, 312 is approximately parallel to the top surface 320 of the platform 110.

FIG. 3B is a perspective view of the electric-vehicle service station 10 in a fourth state according to an embodiment. In the fourth state, the retractable walls 140 are in the lowered state and the platform 110 is in the contracted state. The EV service station 10 can be in the fourth state when transporting the EV service station 10 to a given site, such as a parking lot or the side of a street. The EV service station 10 can also be in the fourth state when the EV service station 10 is deployed in a relatively small space and while an EV is being serviced or while the EV service station 10 is not operational (e.g., outside of business hours) to limit access to the EV service station 10.

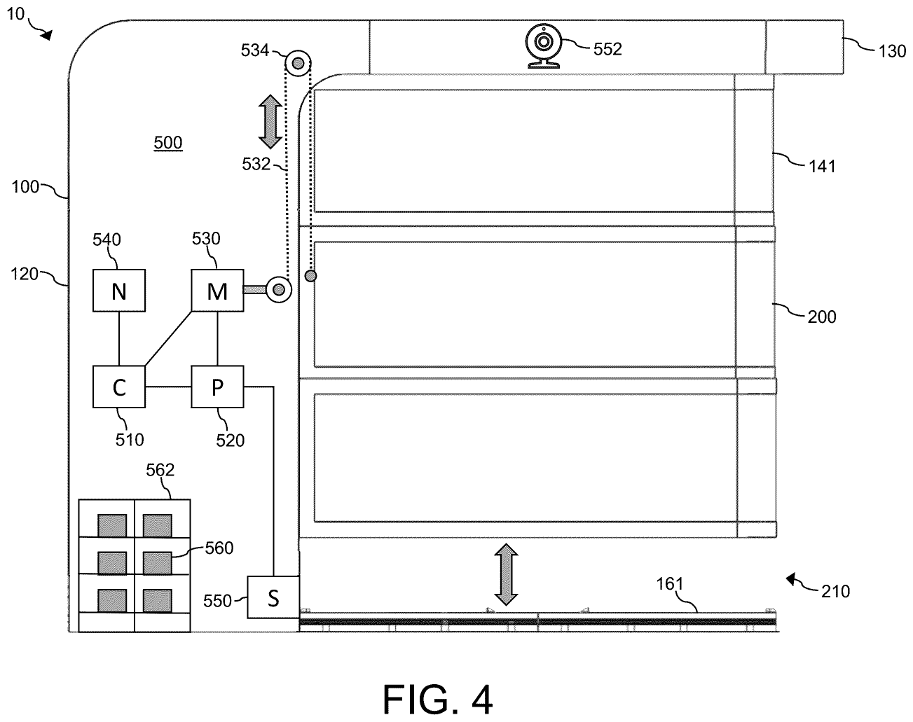

FIG. 4 is a side view of the EV service station 10 as one of the retractable walls (e.g., retractable wall 141) transitions between the contracted and lowered states. The housing wall 120 is transparent in this figure to illustrate additional features of the EV service station 10.

The housing wall 120 is hollow to provide an EV service-station equipment chamber 500. A controller 510, a processor 520, one or more motors 530 (e.g., wall motor(s)), and a network interface 540 are located in the EV service-station equipment chamber 500. The controller 510 is in electrical communication with the processor 520, the motor 530, and the network interface 540. The controller 510 is configured to send control signals to the motor(s) 530 that cause the motor(s) 530 to transition the retractable walls 140 from the lowered state to the retracted state or from the retracted state to the lowered state. For example, the motor(s) 530 can rotate in a first direction to transition the retractable walls 140 from the lowered state to the retracted state and the motor(s) 530 can rotate in a second direction, opposite to the first direction, to transition the retractable walls 140 from the retracted state to the lowered state. The motor(s) 530 is/are mechanically coupled to each retractable wall 140 (e.g., retractable walls 141-143), for example through a chain 532 and pulleys 534.

The controller 510 can also be in electrical communication with motors 171, 172 (FIGS. 1, 3). For example, controller 510 can send control signals to the motors 171, 172 that cause the motors 171, 172 to transition the platform 110 from the extended state to the retracted state or from the retracted state to the extended state.

The processor 520 is in electrical communication with sensors 550. The sensors 550 can include weight sensors (e.g., weight sensor 220), optical sensors (e.g., camera 230 and/or camera 552), and/or other sensors as described herein. The sensors 550 can produce output signals that can be used and/or interpreted by the processor 520 to detect the presence, position, and/or motion of the EV 150.

For example, the processor 520 can determine from the output signals of the camera 552 and/or another sensor 550 that an EV (e.g., EV 150) is approaching the EV service station 10. In response to determining that the EV is approaching the EV service station 10, the processor 520 can send a first control signal to the controller 510. In response to the first output signal, the controller 510 can send a second control signal to the motor(s) 530 that causes the retractable walls 140 to transition from the lowered state to the retracted state. Next, the processor 520 can determine from the output signals of the camera 230, the weight sensor 220, and/or another sensor 550 that the EV (e.g., EV 150) has driven onto the platform 110 and is in position below the roof 130. In response to determining that the EV has driven onto the platform 110 and is in position below the roof 130, the processor 520 can send a third control signal to the controller 510. In response to the third control signal, the controller 510 can send a fourth control signal to the motor(s) 530 that causes the retractable walls 140 to transition from the retracted state to the lowered state. After the retractable walls 140 are in the lowered state, the processor 520 can send one or more control signals that cause one or more discharged batteries in the EV to be swapped with one or more charged batteries 560 from a battery charging rack 562 in the EV service-station equipment chamber 500. After the batteries have been swapped, the processor 520 can send a fifth control signal to the controller 510. In response to the fifth control signal, the controller 510 can send a sixth control signal to the motor(s) 530 that causes the retractable walls 140 to transition from the lowered state to the retracted state.

A battery-swapping robot can be used to swap the discharged and charged batteries. Additional details of an example battery-swapping robot and/or other aspects of the EV service station are described in application Ser. No. 18/317,985, titled “Configurable Vehicle Lift and Service Station,” filed on May 16, 2023 and/or application Ser. No. 18/318,001, titled “Battery-Exchange System and Service Station,” filed on May 16, 2023, which are hereby incorporated by reference.

The processor 520 can also produce output control signals that cause the controller 510 to transition the platform 110 from the extended state to the retracted state or from the retracted state to the extended state.

The network interface 540 can include a wireless communication link, such as an antenna and modem, that can allow the controller 510 and/or processor 520 to communicate with external devices and/or servers. For example, the network interface 540 can wirelessly couple the EV service station 10 to a local- or wide-area network, which can be directly or indirectly coupled to the internet, a virtual private network, or another network. Additionally or alternatively, the network interface 540 can include a wired communication link, such as a wired communication port and a modem, that can allow the controller 510 and/or processor 520 to communicate with external devices and/or servers.

In an embodiment, the network interface 540 can receive one or more data signals from a server and/or from an EV relating to an EV service request. The data signals can include details on the number of batteries to be exchanged with an EV, credits and/or debits to the user's account, and/or the location of the EV. The processor 520 can use the location of the EV, such as GPS coordinates of the EV, to determine when the EV is approaching the EV service station 10 (e.g., in addition or in the alternative to the output signals from the camera 552 and/or another sensor 550 as discussed above).

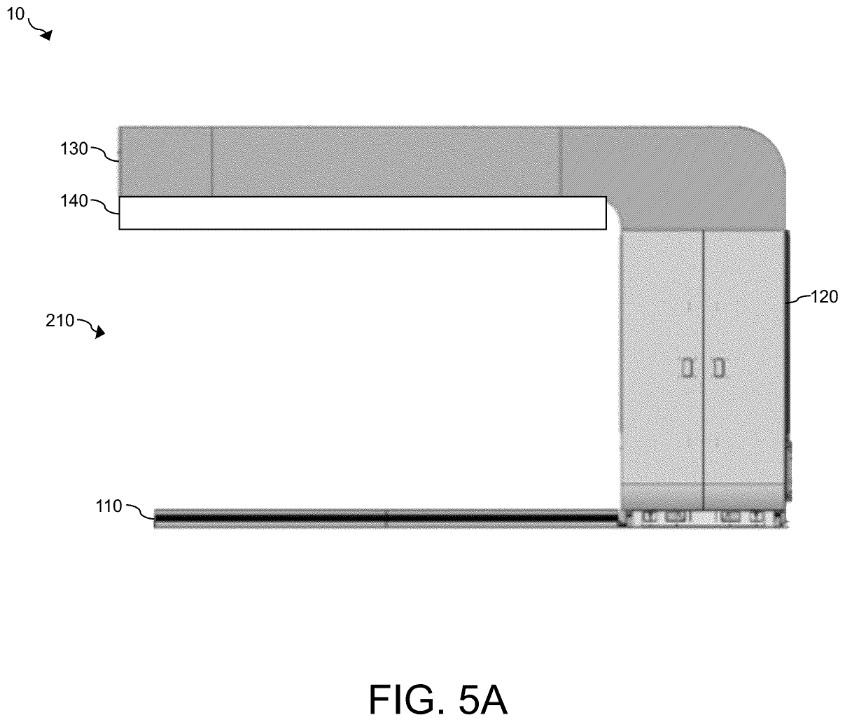

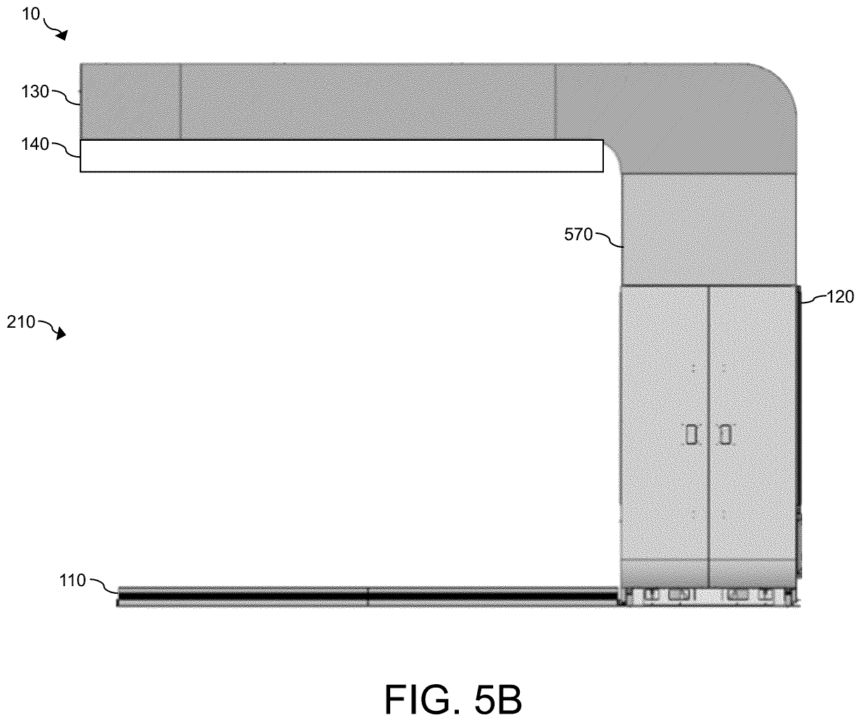

FIGS. 5A and 5B are front views of the EV service station 10 with the walls 140 in a retracted state according to an embodiment. The roof 130 can be modularly attached to the housing wall 120 to allow for a variable roof height. A modular housing-wall extender 570 can be attached to the top the housing wall 120, as illustrated in FIG. 5B. The roof 130 can be attached to the housing-wall extender 570 (FIG. 5B) to increase the height of the roof 130 compared to when the roof 130 is attached to the housing wall 120. Increasing the height of the roof 130 increases the height of the EV service chamber 210 to allow for higher EVs such as trucks to use and access the EV service station 10.

The height of the modular housing-wall extender 570 can be set to provide a target height of the roof 130 and a corresponding target height of the EV service chamber 210. In some embodiments, multiple housing-wall extender 570 having different heights can be provided to switch between different target heights of the roof 130 and respective target heights of the EV service chamber 210.

In other embodiments, the housing wall 120 can telescope upwards and downwards to provide a variable roof height.

In some embodiments, the retractable walls 140 in the extended state can lock to the platform 110, for example to improve security during use and/or to prevent theft or vandalism (e.g., when the EV service station is not in use).

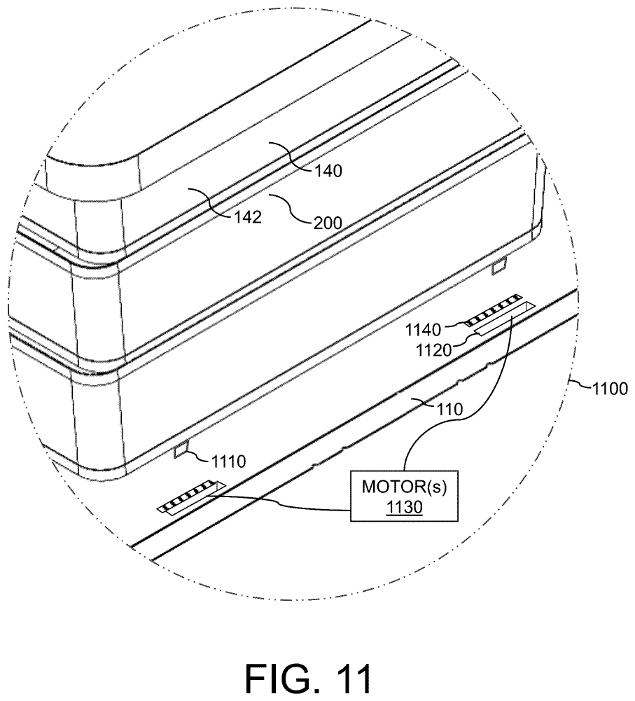

For example, the bottom of the one or more of the retractable walls 140 can include a latching mechanism such as a striker 1110, as illustrated in FIG. 11 which is a detailed view of region 1100 in FIG. 2 according to an embodiment. The striker 110 is configured to mechanically engage a strike slot 1120 defined in the platform 110. The strike slot 1120 can have a length that can receive the striker 1110 regardless of the extension/retraction state of the platform 110. When the striker 1110 is in the striker slot 1120, one or more motor 1130 can cause a latch in the slot 1120 to mechanically engage the striker 1110 to lock the retractable walls 140 in the extended state. The motors(s) 1130 can also cause the latch in the striker slot 1120 to mechanically disengage the striker 1110 to unlock the retractable walls 140. An emergency release button or bar 1140 can unlock the retractable walls, for example in the event that the motor(s) 1130 are not functioning or are not responsive.

In other embodiments, the striker slot 1120 can be located in the bottom of the retractable walls 140 and the striker 1110 can be located on the platform 110.

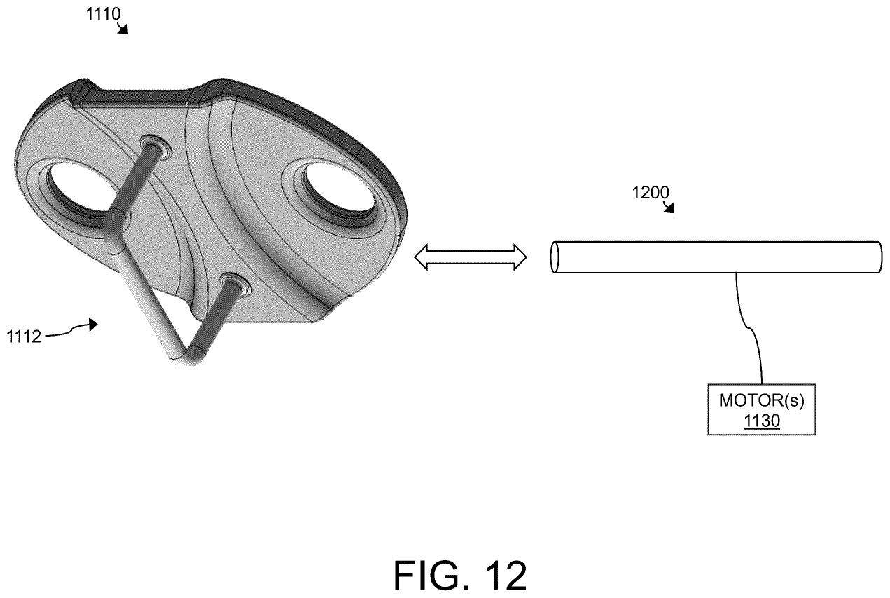

An example striker 1110 and latch 1200 is illustrated in FIG. 12. When the motor(s) 1130 move the latch 1200 laterally inside the frame of the striker 1110, the striker 1110 is locked. When the motor(s) 1130 move the latch 1200 laterally away from the frame 1112 of the striker 1110, as illustrated, the striker 1110 is unlocked.

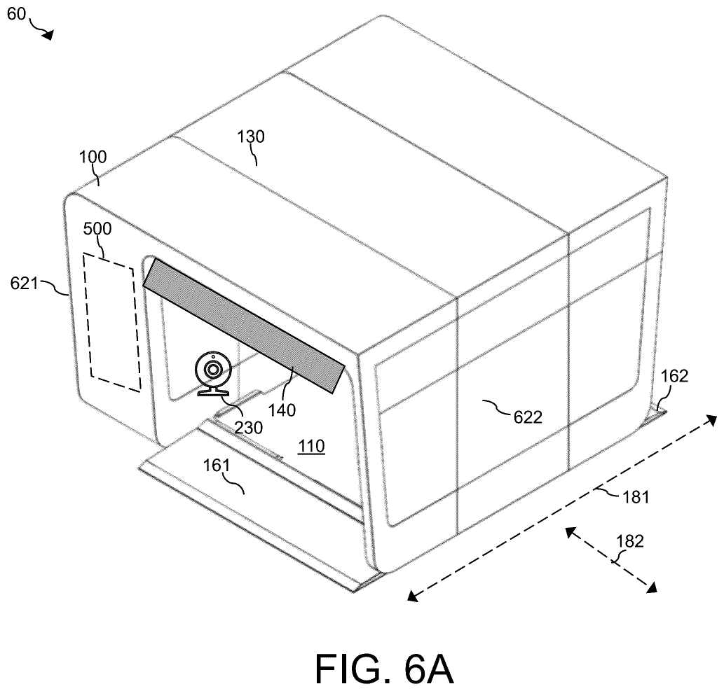

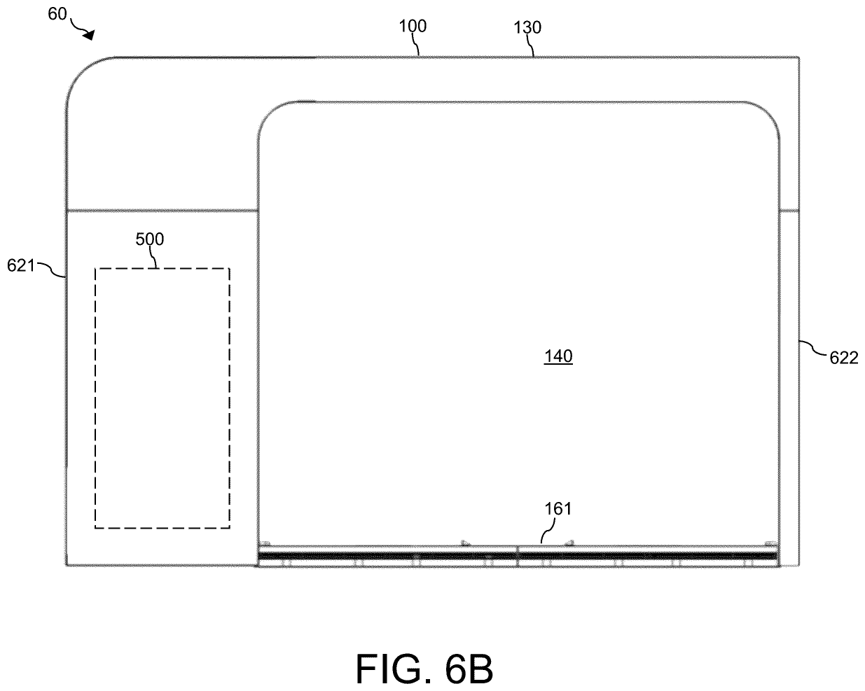

FIG. 6A is a perspective view of an EV service station 60 in a first state according to another embodiment. EV service station 60 is the same as EV service station 10 except that the housing 100 of EV service station 60 includes first and second housing walls 621, 622 instead of the single housing wall 120. The first housing wall 621 is the same as housing wall 120. Thus, both housing walls 621, 120 include an EV service-station equipment chamber 500 (FIG. 4). EV service station 60 can be configured in the same states as EV service station 10. The service station 60 may be portable and formed of modular components/structures.

The first and second housing walls 621, 622 are spaced apart such that the platform 100 is located between and/or attached to the first and second housing walls 621, 622. The first and second housing walls 621, 622 are attached to and/or integrally formed with the roof 130. In addition, the first and second housing walls 621, 622 are stationary.

The second housing wall 622 has a thinner width than the first housing wall 621, as measured with respect to the second axis 182. The roof 130 is attached to and/or integrally formed with the first and second walls 621, 622.

EV service station 60 includes two retractable walls 140 (only one retractable wall 140 is viewable in this perspective view). The retractable walls 140 are extended parallel to each other and to the second axis 182. One retractable wall 140 is located at the entrance of the EV service station 60, and the other retractable wall 140 is located at the exit of the EV service station 60. The retractable walls 140 are in the retracted state and the platform 110 is in the contracted state in this figure. The retractable walls 140 can alternately be referred to as retractable doors.

FIG. 6B is a side view of the EV service station 60 in a second state according to embodiment. In the second state, the two retractable walls 140 (only one retractable wall 140 is viewable in this side view) are in the lowered state.

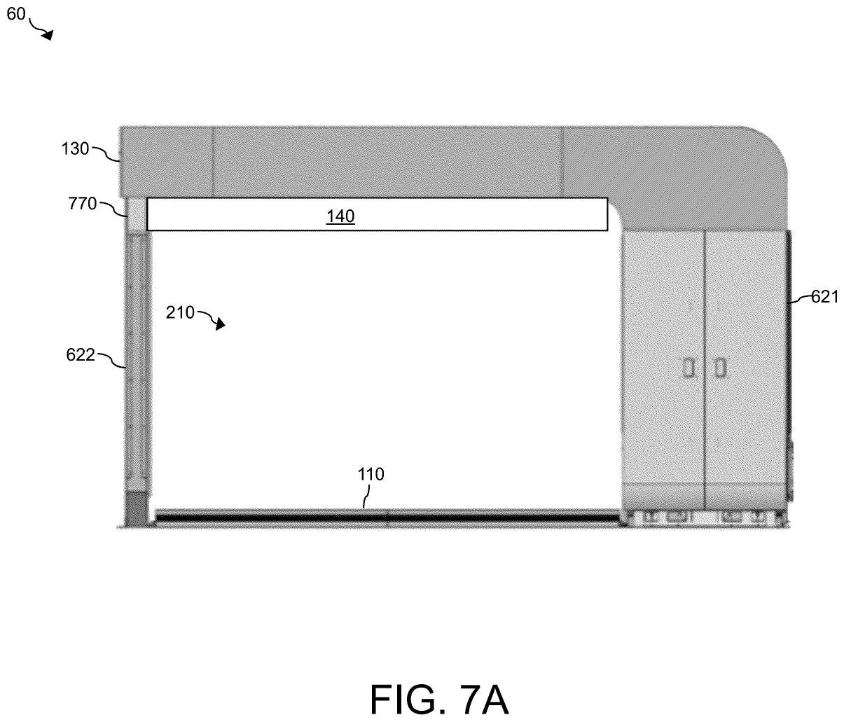

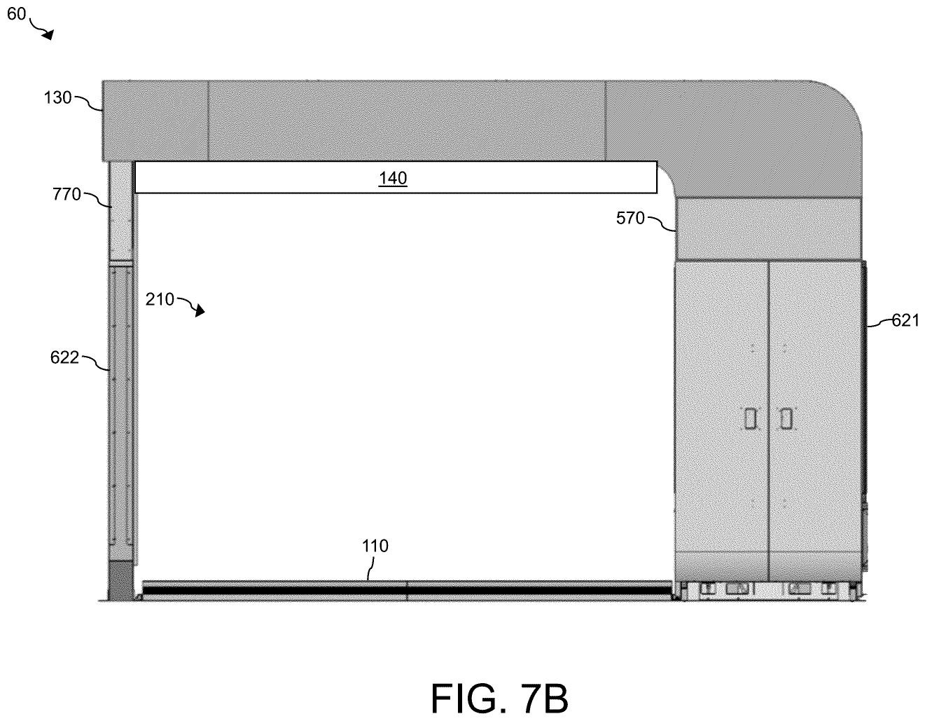

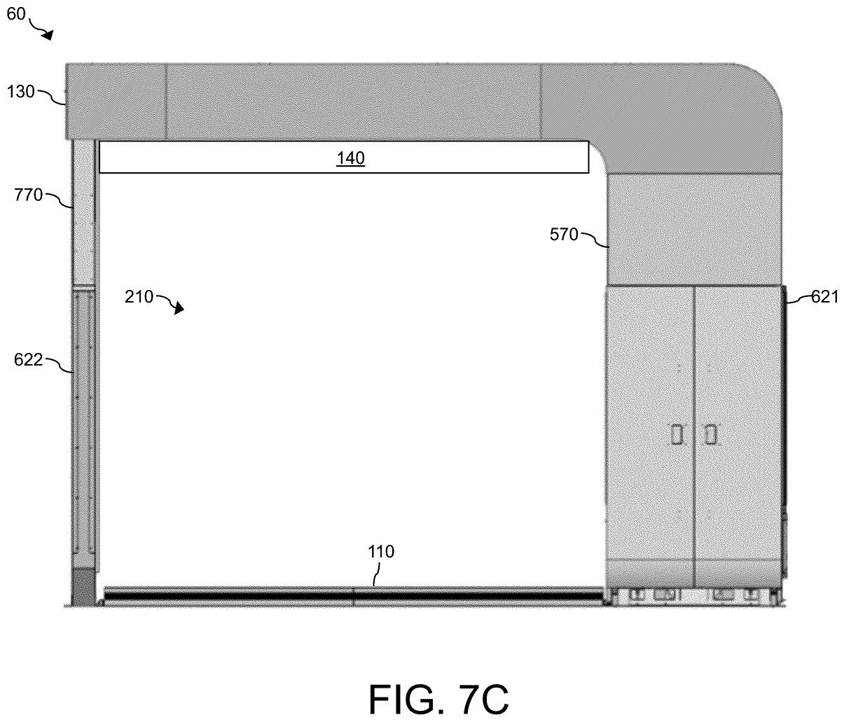

FIGS. 7A-7C are front views of the EV service station 60 with the walls 140 in a retracted state according to an embodiment. The roof 130 can be modularly attached to the housing walls 621, 622 to allow for a variable roof height in the same manner as discussed above with respect to FIGS. 5A and 5B. First and second housing-wall extenders 570, 770 are attached to the first and second housing walls 621, 622, respectively to set the height of the roof 130. The length/height of the first and second housing-wall extenders 570, 770 can be varied to customize the height of the 130 and the corresponding height of the EV service chamber 210.

FIGS. 7B and 7C are examples of the housing-wall extender 570 having different heights.

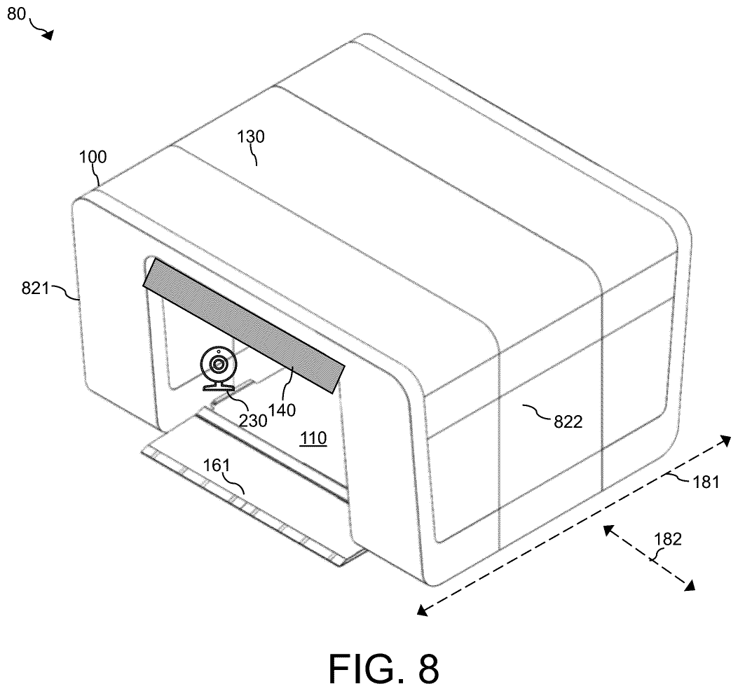

FIG. 8 is a perspective view of an EV service station 80 in a first state according to another embodiment. EV service station 80 is the same as EV service station 60 except that in EV service station 80 the first and second housing walls 821, 822 have the same or about the same width, as measured with respect to the second axis 182, while in EV service station 60 the first second housing wall 621 is wider than the second housing wall 622, as measured with respect to the second axis 182. The wider second housing wall 822 can be used to store additional components. For example, both the first and second housing walls 821, 822 can include a respective EV service-station equipment chamber 500. The equal (or substantially equal) width of the first and second walls 821, 822 can also improve the aesthetic features of an EV service station 80 compared to EV service station 60. EV service station 80 can be configured in the same states as EV service station 10.

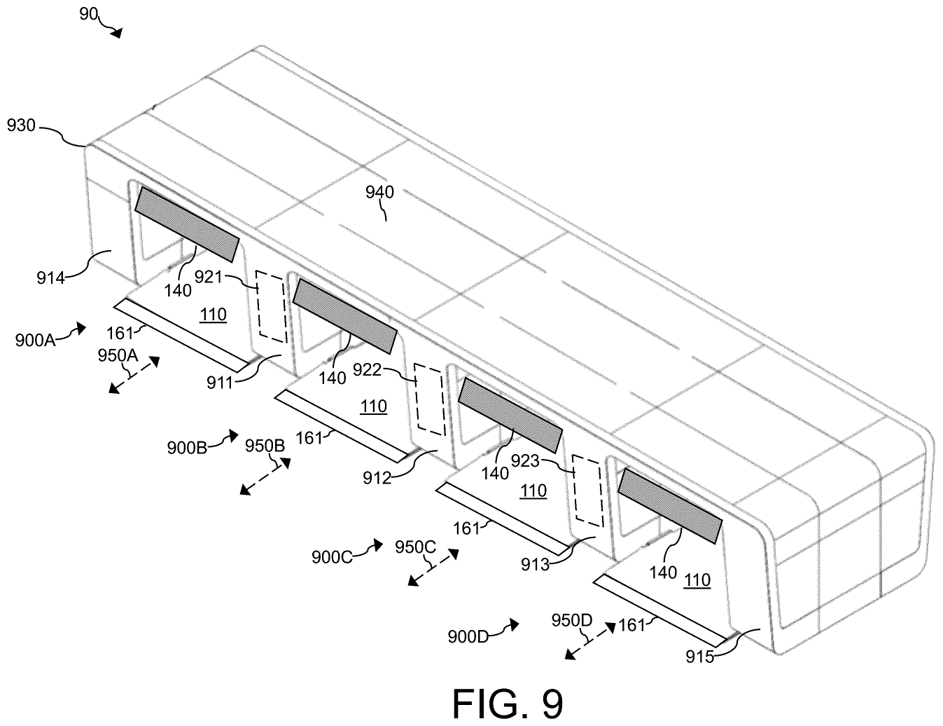

FIG. 9 is a perspective view of an EV service stations array 90 according to an embodiment. The array includes a plurality of EV service stations 900A-D (in general, EV service stations 900). Each EV service station 900 can be the same as EV service station 80 or EV service station 60. The array 90 can include additional or fewer EV service stations 900.

In the array 90, each EV service station shares at least one housing wall with a neighboring EV service station. For example, EV service stations 900A, 900B share a common inner housing wall 911, EV service stations 900B, 900C share a common inner housing wall 912, and EV service stations 900C, 900D share a common inner housing wall 913. The first and last EV service stations 900A, 900D have a respective outer housing wall 914, 915 that is not shared with a neighboring EV service station.

In an embodiment, each common inner housing wall 911-913 has a respective EV service-station equipment chamber 921-923, which can be the same as EV service-station equipment chamber 500. Each EV service-station equipment chamber can be shared with the respective neighboring EV service stations. For example, common/shared EV service-station equipment chamber 921 can be shared with EV service stations 900A, 900B, common/shared EV service-station equipment chamber 922 can be shared with EV service stations 900B, 900C, and common/shared EV service-station equipment chamber 923 can be shared with EV service stations 900C, 900D. This configuration allows equipment such as a controller (e.g., controller 510), processor (e.g., processor 520), network interface (e.g., network interface 540), charged batteries (e.g., charged batteries 560), and/or battery charging rack (e.g., battery charging rack 562) in each common/shared EV service-station equipment chamber to be shared with the adjoining/neighboring EV service stations. Each EV service station 900 preferably has its own motors to drive the respective pair of retractable walls 140 (only one retractable wall 140 for each EV service station 900 is viewable in FIG. 9).

In an optional embodiment, one or both outer housing walls 914, 915 can include a respective EV service-station equipment chamber, which can be the same as EV service-station equipment chamber 500.

The array 90 includes a housing 930 that includes the common inner housing walls 911-913, the outer housing walls 914, 915, and a roof 940. The housing walls 911-913, the outer housing walls 914, 915, and/or the roof 940 can be attached together and/or integrally formed together.

Each platform 110 extends along a respective central axis 950A-D (in general, central axis 950) which are parallel to each other. The first and second retractable walls 140 of each EV service station 900 are aligned and/or centered with respect to the respective central axis 950. The central axis 950 can be an axis of symmetry for each EV service station 900. Each EV service station 900 is aligned and/or centered with respect to the respective central axis 950.

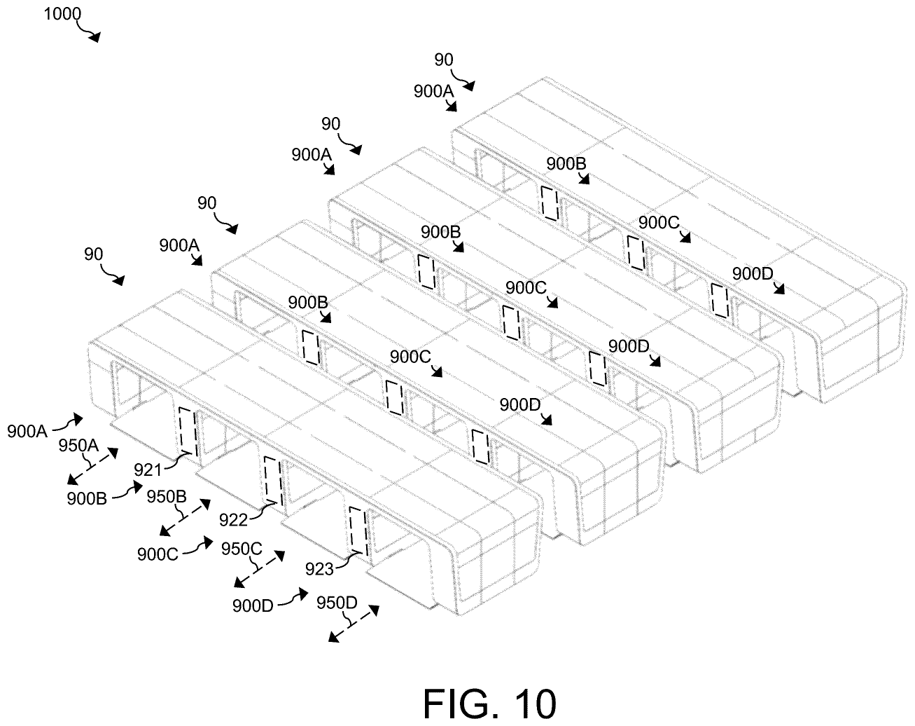

FIG. 10 is a perspective view of an EV service station matrix 1000 that includes a plurality of arrays 90 of EV service stations 900. The arrays 90 are aligned such that a first EV service station 900A of each array 90 is aligned and/or centered with respect to a first central axis 950A, a second EV service station 900B of each array 90 is aligned and/or centered with respect to a second central axis 950B, a third EV service station 900C of each array 90 is aligned and/or centered with respect to a third central axis 950C, and a fourth EV service station 900D of each array 90 is aligned and/or centered with respect to a fourth central axis 950D.

Each array 90 can include additional or fewer EV service stations 900. Each array 90 preferably has the same number of EV service stations 900. The matrix 1000 can include additional or fewer arrays 90.

The arrays 90 in matrix 1000 can be spaced apart such that EVs can drive into an EV service station 900 in any of the arrays 90. Alternatively, the arrays 90 can be spaced close together such that an EV would drive through a “column” of EV service stations 900 (e.g., the first EV service station 900A in each array 90) until a last available EV service station 900 is reached (e.g., in a given “row” or matrix 90). The processor in one of the EV service-station equipment chambers 921-923 in one of the arrays 90 or another processor can execute program instructions that can direct the EV to the appropriate EV service station 900 in a column and row matrix 1000.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

This disclosure thus supports several exemplary embodiments.

1. A portable electric-vehicle (EV) battery service station, comprising:
a platform configured to receive an EV;
a housing attached to the platform, the housing including a stationary housing wall and a roof supported by the stationary housing wall, the roof overhanging the platform;
a plurality of retractable walls attached to the roof, the retractable walls having a raised state in which the retractable walls are raised to allow the EV to drive onto or off of the platform and a lowered state in which the retractable walls extend to the platform such that the stationary housing wall, the retractable walls, the roof, and the platform define an EV service chamber; and
one or more motors in mechanical communication with the retractable walls to transition the retractable walls between the raised and lowered states.

2. The portable EV battery service station of claim 1, wherein:
the stationary housing wall is a first stationary housing wall,
the housing includes a second stationary housing wall attached to the roof, and
the platform is located between the first and second stationary housing walls.

3. The portable EV battery service station of claim 1, further comprising:
a first ramp attached to a first side of the platform; and
a second ramp attached to a second side of the platform, the first and second ramps aligned along an axis.

4. The portable EV battery service station of claim 3, wherein:
the one or more motors is/are wall motor(s),
the platform is configured to telescope between an extended state and a contracted state, and
one or more platform motors is/are in mechanical communication with the platform to transition the platform between the extended and contracted states.

5. The portable EV battery service station of claim 1, wherein the stationary housing wall defines an EV service-station equipment chamber.

6. The portable EV battery service station of claim 5, further comprising a battery charging rack located in the EV service-station equipment chamber.

7. The portable EV battery service station of claim 5, further comprising:
a controller in electrical communication with the motor(s), the controller configured to produce a first motor control signal that causes the motor(s) to transition the retractable walls between the raised and lowered states; and
a processor in electrical communication with the controller, the processor configured to produce a processor control signal in response to one or more input signals,
wherein the controller produces the motor control signal in response to receiving the processor control signal.

8. The portable EV battery service station of claim 7, further comprising one or more sensors configured to detect a position of the EV with respect to the EV service station, wherein:
the processor is configured to receive output signals from the sensor(s),
the processor is configured to produce a first processor control signal when the processor determines, using the output signals from the senor(s), that the EV is approaching the platform, and
in response to receiving the first processor control signal, the controller causes the motor(s) to transition the retractable walls from the lowered state to the raised state.

9. The portable EV battery service station of claim 8, wherein:
the processor is configured to produce a second processor control signal when the output signals indicate that the EV is located on the platform and below the roof, and
in response to receiving the second processor control signal, the controller causes the motor(s) to transition the retractable walls from the raised state to the lowered state.

10. The portable EV battery service station of claim 9, wherein:
the processor is configured to produce a third processor control signal after one or more depleted batteries in the EV are exchanged with one or more charged batteries, and
in response to receiving the third processor control signal, the controller causes the motor(s) to transition the retractable walls from the lowered state to the raised state.

11. The portable EV battery service station of claim 10, wherein the sensor(s) include a camera and/or a weight sensor.

12. The portable EV battery service station of claim 7, wherein the processor and the controller are located in the EV service-station equipment chamber.

13. The portable EV battery service station of claim 1, further comprising a housing-wall extender attached to a top the stationary housing wall and to the roof, the housing-wall extender having dimensions that are configured to increase a height of the roof compared to when the roof is attached to the top the stationary housing wall.

14. The portable EV battery service station of claim 1, further comprising a locking mechanism configured to lock the retractable walls to the platform when the retractable walls are in the lowered state.

15. An electric-vehicle (EV) battery service station array, comprising:
a plurality of platforms, each platform configured to receive a respective EV for a respective EV service station;
a housing attached to the platforms, the housing including a plurality of stationary housing walls and a roof attached to the stationary housing walls, the roof overhanging the platforms, wherein each platform is located between a respective pair of stationary housing walls;
a plurality of pairs of retractable walls attached to the roof, each pair of retractable walls aligned with a respective platform, each pair of retractable walls having a respective raised state to allow the respective EV to drive onto or off of the respective platform and a respective lowered state in which the respective pair of retractable walls extend to the respective platform such that the respective pair of stationary housing walls, the respective pair of retractable walls, the roof, and the respective platform define a respective EV service chamber; and
a respective one or more motors in mechanical communication with each pair of retractable walls to transition the respective pair of stationary housing walls between the respective raised state and the respective lowered state.

16. The EV battery service station array of claim 15, wherein the stationary housing walls include first and second outer housing walls and one or more inner housing walls, each inner housing wall located between neighboring EV service chambers.

17. The EV battery service station array of claim 16, wherein each inner wall defines a respective EV service-station equipment chamber that includes shared equipment for the neighboring EV service chambers.

18. The EV battery service station array of claim 17, wherein the shared equipment includes a battery charging rack.

19. The EV battery service station array of claim 17, wherein the shared equipment further includes:
a controller in electrical communication with the respective motor(s) for the pairs of retractable walls of the neighboring EV service chambers; and
a processor in electrical communication with the controller, the processor configured to produce a processor control signal in response to one or more input signals.

20. An electric-vehicle (EV) battery service station matrix comprising:
a plurality of EV service station arrays, each EV service station array comprising:
a plurality of platforms, each platform configured to receive a respective EV for a respective EV service station;
a housing attached to the platforms, the housing including a plurality of stationary housing walls and a roof attached to the stationary housing walls, the roof overhanging the platforms, wherein each platform is located between a respective pair of stationary housing walls;
a plurality of pairs of retractable walls attached to the roof, each pair of retractable walls aligned with a respective platform, each pair of retractable walls having a respective raised state to allow the respective EV to drive onto or off of the respective platform and a respective lowered state in which the respective pair of retractable walls extend to the respective platform such that the respective pair of stationary housing walls, the respective pair of retractable walls, the roof, and the respective platform define a respective EV service chamber; and
a respective one or more motors in mechanical communication with each pair of retractable walls to transition the respective pair of stationary housing walls between the respective raised state and the respective lowered state,
wherein the EV service station arrays are aligned such that a first EV service station in each EV service station array is aligned with respect to a first central axis and a second EV service station in each EV service station array is aligned with respect to a second central axis.
